(19) United States
(12) Patent Application Publication
(10) Pub. No.: US 2008/0004962 A1
(43) Pub. Date: Jan. 3, 2008

(54) Slot preference auction

(76) Inventors: Shanmugavelayutham Muthukrishnan, New York, NY (US); Martin Pal, Metuchen, NJ (US)

Correspondence Address: FISH & RICHARDSON P.C., PO BOX 1022, MINNEAPOLIS, MN, 55440-1022, US

(21) Appl. No.: 11/479,942

(22) Filed: Jun. 30, 2006

(51) Int. Cl. G06Q 30/00

(52) U.S. Cl. 705/14

(57) ABSTRACT

A method for auctioning advertisement positions in a medium is disclosed. The method comprises receiving slot preference information comprising a first series of rankings at which an advertiser prefers to place a first advertisement relative to other advertisements on a medium, wherein two or more of the rankings in the first series are non-sequential, receiving a single bid for placement of the first advertisement at any of the rankings in the first series, and associating the first advertisement with a first ranking in the first series if the first ranking has not been previously associated with a different advertisement.

### TECHNICAL FIELD

The instant specification relates to advertisement auctions and, more particularly, to auctions for particular placement of advertisements.

### BACKGROUND

As the Internet has become increasingly popular, more and more advertisements (ads) are being placed on web pages in order to reach a growing audience of Internet users. The position in which these ads are placed may increase the visibility, and thus, the success of the ads. For example, an ad placed at the top of a page ahead of other ads may be more visible to viewers than an ad placed between several other ads.

Certain current systems accept ads and publish them on the Internet for viewing. The current systems may use an auction process to assign an ad to an available position on a web page. For example, an advertiser who submits a highest bid can receive a position at the top of a web page, an advertiser who submits a second highest bid can receive the position under the first ad, etc. This auction system, however, may not provide advertisers with the flexibility to select a particular position for their ads. Instead, the highest bidding advertiser is assigned the next sequentially available position regardless of whether the advertiser prefers that position or not.

### SUMMARY

In one implementation, a method for auctioning advertisement positions in a medium is described. The method comprises receiving slot preference information comprising a first series of rankings at which an advertiser prefers to place a first advertisement relative to other advertisements on a medium, wherein two or more of the rankings in the first series are non-sequential, receiving a single bid for placement of the first advertisement at any of the rankings in the first series, and associating the first advertisement with a first ranking in the first series if the first ranking has not been previously associated with a different advertisement. The first series of rankings may be formatted as a preference list ordered from a most preferred ranking for placement of the first advertisement to a least preferred ranking. The method may also comprise associating the first advertisement with a second ranking in the first series if the first ranking has been previously associated with the different advertisement and the second ranking is available for assignment. In addition, the method may comprise receiving second slot preference information comprising a second series of rankings at which a second advertiser prefers to place a second advertisement and receiving a second single bid for placement of the second advertisement.

In some aspects, the method may include associating the second advertisement with a ranking in the second series before associating the first advertisement with a ranking in the first series if the second single bid is greater than the first single bid. The medium may also be selected from a group consisting of a web page, a printed page, a television time schedule, and a radio time schedule. The method may also include receiving from a second advertiser a second single bid for placement of a second advertisement, and assigning a default series of rankings for the second advertisement if slot preference information associated with the second single bid is not received. The default series of rankings may order the rankings sequentially, and the method may also comprise receiving slot preference information and corresponding single bids from multiple advertisers, and processing the slot preference information from an advertiser submitting a higher bid before slot preference information from an advertiser submitting a lower bid.

In some aspects, the single bid may be a weighted bid comprising a click through rate for the first advertisement and a cost-per-impression bid. Also, the first series of rankings may be a subset of a greater set of available rankings permitted for the medium. The method may further comprise executing a default policy to eliminate or fill positions indicated by rankings if one or more of the available rankings are not associated with an advertisement. In addition, the default policy may comprise voiding previous associations between rankings and advertisements, reducing the number of available rankings, receiving new slot preference information and a new associated single bid, and associating advertisements with rankings based on the new slot preference information and the new associated single bid. In some examples, the default policy may comprise associating default advertisements with rankings not associated with an advertisement, or incrementing the ranking of an advertisement that is ranked below a ranking that is not associated with an advertisement.

In other aspects, the method may further include charging the advertiser a fee for associating the first advertisement with the first ranking, wherein the fee is substantially equal to a next highest single bid submitted by a second advertiser regardless of whether the second advertiser submitted slot preference information that included the first ranking. The method may also include charging the advertiser a fee for associating the first ranking with the first advertisement, wherein the fee is substantially equal to a single bid of another advertiser that prefers the first ranking and has the next highest bid. The slot preference information may further comprise a preferred size, shape, or color of the advertisement.

In another implementation, a method for auctioning advertisement positions is disclosed, and comprises receiving preference lists from advertising bidders, each list comprising a series of positions at which an advertising bidder prefers to place an advertisement on a medium, receiving bids from the advertising bidders, each bid associated with a preference list, determining that one or more of the advertising bidders are eligible if an advertisement of the one or more advertising bidders has not been previously assigned a position, selecting a preference list of an eligible advertising bidder submitting a highest bid of the bids from the eligible one or more advertising bidders, and assigning an advertisement of the eligible advertiser bidder with the highest bid to the first position listed in the selected preference list that has not been previously assigned to a different advertisement. The method may further comprise charging the eligible advertising bidder an amount substantially equal to a second highest bid of the eligible one or more advertising bidders, or receiving a reserve price for one or more of the positions. The method may also include determining an advertisement can not be assigned a position if a bid submitted by a bidder associated with the advertisement is not substantially equal to or greater than the associated reserve price.

In yet another implementation, a method for auctioning positions for advertisement placement is disclosed. The method includes receiving preference lists and corresponding bids from advertising bidders, each list comprising positions at which an advertising bidder prefers to place an advertisement, selecting an advertising bidder that has a highest bid among advertising bidders not previously selected, and assigning a position price to each position in a preference list of the selected advertising bidder, wherein the position price of each of the positions is substantially equal to the greater of a highest position price assigned to the position in preference lists of unselected advertising bidders or the bid of the selected advertising bidder. The method may further comprise receiving a reserve price for one or more of the positions.

In another implementation, a system for determining placement of advertising is disclosed. The system comprises an interface to receive from an advertiser a single bid and an associated preference list that specifies positions the advertiser prefers to locate an advertisement on a medium, wherein the preference list comprises a listing of non-sequential rankings, means for selecting the preference list using the single bid and assigning the advertisement to a ranking in the preference list that has not been previously assigned to another advertisement, and an advertisement positioner that outputs a position for the advertisement based on the assigned ranking.

The systems and techniques described here may provide one or more of the following advantages. First, a system may increase the positioning choices for placement of advertisements positioned according to an auction. Second, a system may provide advertisers with an option to not place an advertisement if a preferred position is not available. Third, a system can increase flexibility associated with performing auctions by permitting one auction to be run or two auctions to be run, where the first auction and the second set of auctions can produce the same advertising positioning and associated placement fees. Fourth, a system can have default auction preferences that result in position assignments compatible with previous auction algorithms.

The details of one or more embodiments of the slot preference auction are set forth in the accompanying drawings and the description below. Other features and advantages of the auction will be apparent from the description and drawings, and from the claims.

### DESCRIPTION OF DRAWINGS

FIG. 1 is a schematic diagram of an example system for auctioning advertisement slots.

FIG. 2 is a block diagram of an example system for auctioning advertisement slots adjacent to a search results portion of a web page.

FIG. 3 is a flow chart of an example process for auctioning advertisement slots.

FIG. 4 is a flow chart of a first example process for pricing auctioned advertisement slots.

FIG. 5 is a table showing a first example of an advertising slot auction using the process of FIG. 4.

FIG. 6 is a flow chart of a second example process for pricing auctioned advertisement slots.

FIG. 7 is a table showing a second example of an advertising slot auction using the process of FIG. 6.

FIG. 8 is a flow chart showing an example process for handling unassigned advertisement slots.

FIG. 9 is a schematic diagram of an example generic computer system.

Like reference symbols in the various drawings indicate like elements.

### DETAILED DESCRIPTION

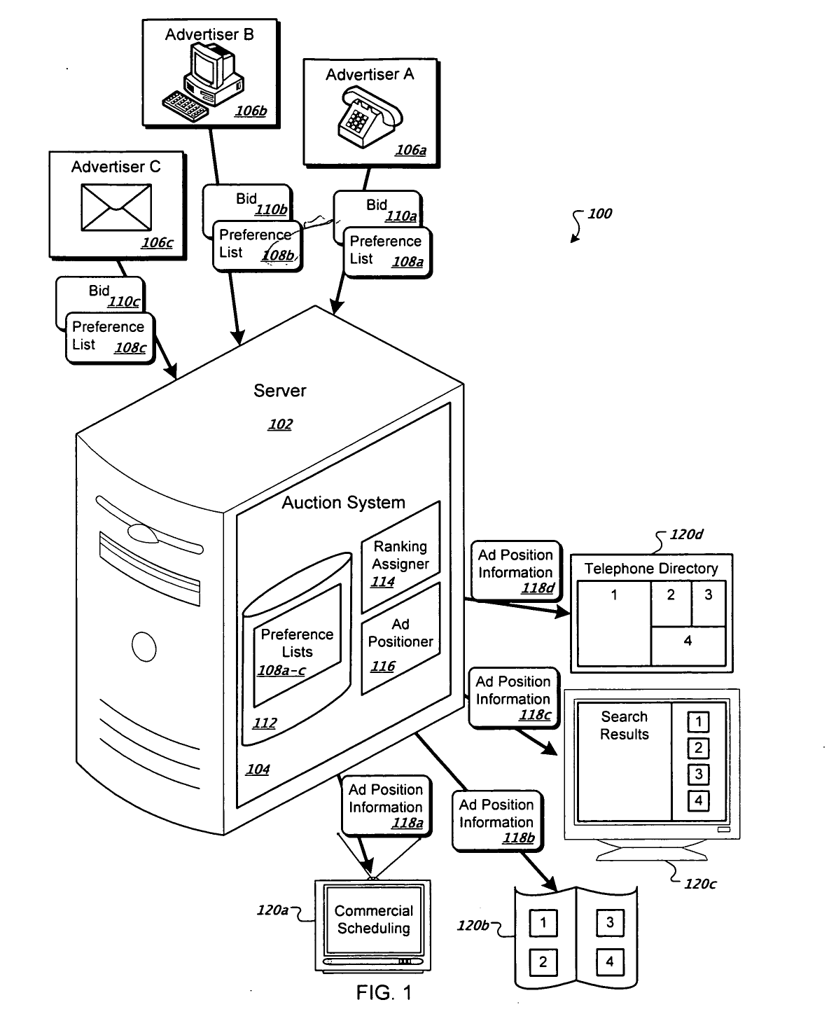

FIG. 1 is a schematic diagram of an example system 100 for auctioning advertisement (ad) slots. The system 100 includes a server 102 containing an auction system 104. The auction system 104 is in communication with one or more advertisers 106a-c, such as by telephone, mail, or a computer network. The auction system 104 receives preference lists 108a-c of desired advertisement slots and bids 110a-c for a slot from each of the advertisers 106a-c, respectively. The auction system 104 stores the preference lists 108a-c and the bids 110a-c in a repository 112. The ranking assigner 114, within the auction system 104, ranks the advertisers' eligible bids from lowest to highest. An eligible bid may be, for example, a bid that meets a reserve bid price, or a minimum bid amount.

An ad positioner 116 determines what slot, if any, will be assigned to each of the advertisers 106a-c. The ad positioner 116 makes a slot assignment to each of the advertisers 106a-c in order from an advertiser (e.g., the advertiser 106a) with a highest eligible bid to an advertiser (e.g., the advertiser 106c) with a lowest eligible bid. The ad positioner 116 assigns slots using the preference lists 108a-c. First, the ad positioner 116 assigns the advertiser 106a with the highest eligible bid 110a a most preferred slot from the advertiser's preference list 108a. Then, the ad positioner 116 assigns the advertiser 106b with the next highest eligible bid 110b an advertisement slot. If the most preferred slot in the list 108b is still available, then the ad positioner 116 assigns that slot to the advertiser 106b. Otherwise, if it is not available, then the ad positioner 116 checks the availability of the next slot in the list 108b. The ad positioner 116 continues until either it finds and assigns an available slot to the advertiser 106b or it determines that all slots in the list 108b are unavailable. The ad positioner 116 continues the assignment process for all of the advertisers 106a-c.

The ad positioner 116 transmits the assignments in ad position information 118a-d to be applied to one or more media 120a-d, such as a web page, a printed page, a television time schedule, or a radio time schedule. In general, preferred slots within a preference list need not be sequential. In certain implementations, a preference list indicates one or more ranges of slot preferences that need not be sequential. Additionally, if preference information is not received from an advertiser, the ad positioner 116 can create default preference information, which can list preferred slots in sequential order. For example, the preference information may indicate that the first slot is preferred first, the second slot is preferred second, etc.

In other implementations, the default preference information may be based on historical selections by other users for the particular medium on which the advertisements will be placed. For example, if the medium is a website and past users have preferred a particular order (e.g., first slot is preferred first, fourth slot is preferred second, and last spot is preferred third), the default preference information will reflect this statistical preference.

In certain implementations, the preference lists 108a-c includes other information, such as a preferred size, shape, or color of the assigned advertisement slot. For example, each of the media 120a-d may include four advertisement slots to be auctioned. The four advertisement slots may be ranked in the preference lists 108a-c according to their sequential order, such as a sequence of commercials in the television medium 120a. In addition, in the telephone directory printed medium 120d, the four slots may be ranked according to size, such as a small size for slots 2 and 3, a medium size for slot 4, and a large size for slot 1. The newspaper printed medium 120b may have color ads on left side pages (slots 1 and 2) and black/white ads on right side pages (slots 3 and 4). The web page medium 120c may have image shapes for slots 1 and 2, and single line text shapes for slots 3 and 4.

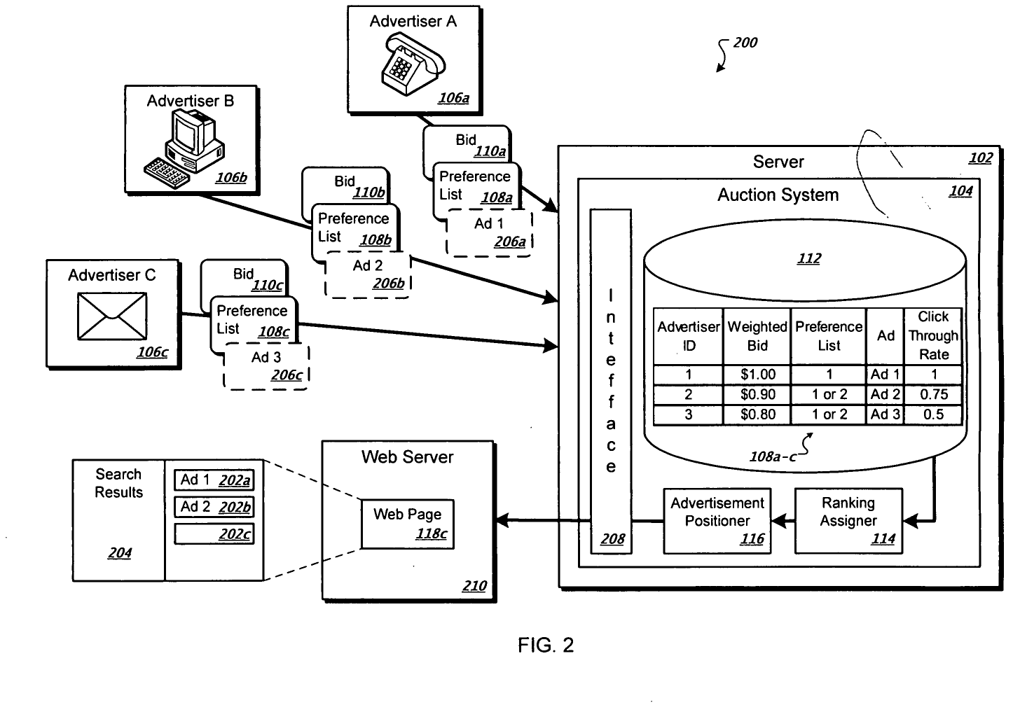

FIG. 2 is a block diagram of an example system 200 for auctioning advertisement slots 202a-c adjacent to a search results portion 204 of the web page 118c. The advertisers 106a-c may provide ads 206a-c with the bids 110a-c and preference lists 108a-c, respectively, to the auction system 104 via an interface 208. The auction system 104 stores the ads 206a-c and the bids 110a-c in the repository 112 with the preference lists 108a-c. The bids 110a-c may be in the form of a cost per impression, where an impression can include a single instance of an ad presentation, or when a viewer performs an action based on the ad presentation (e.g., selects a hyperlink in the ad, makes a purchase after navigating to a web page from the selected hyperlink, etc.).

The auction system 104 may weight the bids 110a-c based on a click through rate (CTR) for an associated ad to determine a weighted bid. The click through rate can be the number of times that a viewer selects a hyperlink included in an ad presented on a web page. For example, a CTR of 1 indicates that, on average, all past viewers have visited the advertiser 106a after viewing the ad 206a. In addition, the CTR of 0.75 indicates that, statistically, three quarters of the viewers of the ad 206b visit the advertiser 106b and the CTR of 0.5 indicates that half of past viewers of the ad 206c have visited the advertiser 106c. The CTR can be multiplied by the submitted bid to generate a weighted bid that favors ads that have high CTRs.

The ranking assigner 114 ranks the advertisers 106a-c according to the bids 110a-c (or the weighted bids) from highest to lowest, that is the advertiser 106a is first, the advertiser 106b is second, and the advertiser 106c is third. The ad positioner 116 determines in which of the slots 202a-c, if any, each of the ads 206a-c will be placed. For example, the advertiser 106a with the highest weighted bid of $1.00 may be assigned its first slot preference from the list 108a, that is the first slot 202a on the web page 118c. The second highest advertiser 106b, having the weighted bid $0.90, is assigned its second slot preference, the second slot 202b, because its first slot preference was taken by the advertiser 106a which had a higher bid. The third advertiser 106c, having the third highest weighted bid of $0.80, is assigned no slots because both of its preferred slots listed in its preference list 108c are already taken. The ad positioner 116 outputs the position information via the interface 208 to a web server 210. The web server 210 presents the ads 206a-b in the slots 202a-b, respectively, along with the search results 204.

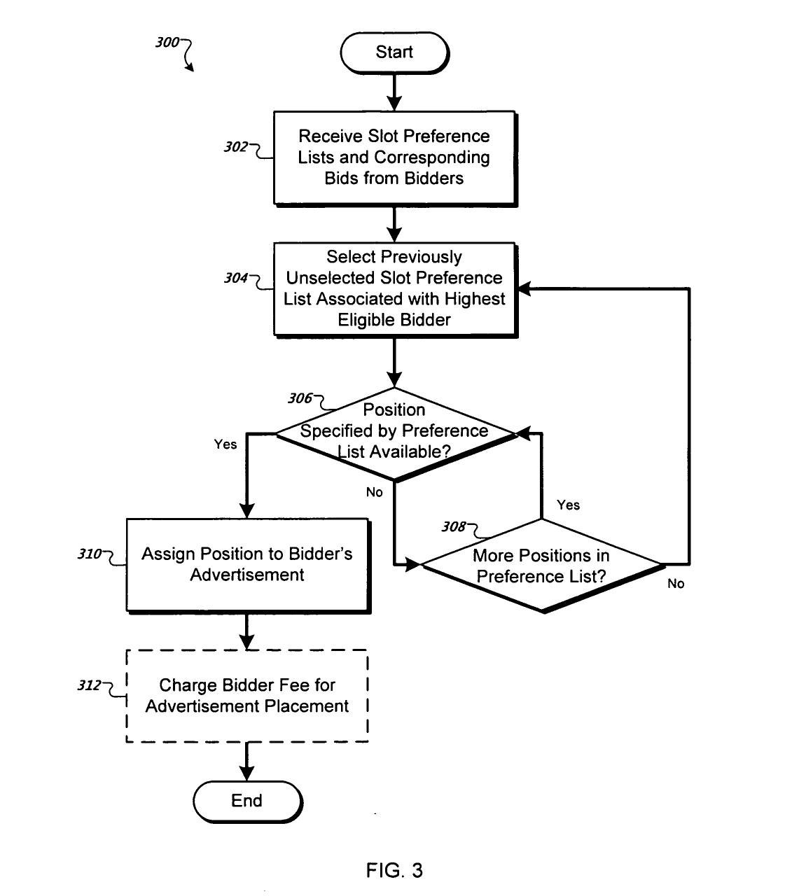

FIGS. 3, 4, 6, and 8 are flow charts of example processes 300, 400, 600, and 800, respectively, for auctioning advertisement slots to advertisers. The processes 300, 400, 600, and 800 may be performed, for example, by a system such as the systems 100 and 200 and, for clarity of presentation, the description that follows uses the systems 100 and 200 as the basis of an example for describing the processes 300, 400, 600, and 800. However, another system, or combination of systems, may be used to perform the processes 300, 400, 600, and 800.

FIG. 3 is a flow chart of an example process 300 for auctioning advertisement slots. Process 300 begins with receiving (302) slot preference lists and corresponding bids from bidders. For example, the auction system 104 receives the preference lists 108a-c and the bids 110a-c from the advertisers 106a-c.

Process 300 selects (304) a previously unselected slot preference list associated with a highest eligible bidder. In certain implementations, the highest eligible bidder can be a bidder that has not already been assigned an advertisement slot and has a bid that is at least as high as a reserve bid. For example, the ranking assigner 114 may select the preference list 108a associated with the advertiser 106a.

If a position specified by the selected preference list is not available (306) and more positions in the preference list exist (308) in the list, then process 300 continues until a position is found that is still available or no more positions exist. If no more positions exist in the preference list, then process 300 selects (304) another previously unselected slot preference list submitted by the next highest eligible bidder. Otherwise, if a preferred position is determined to be available, then process 300 assigns (310) the position to the bidder's advertisement.

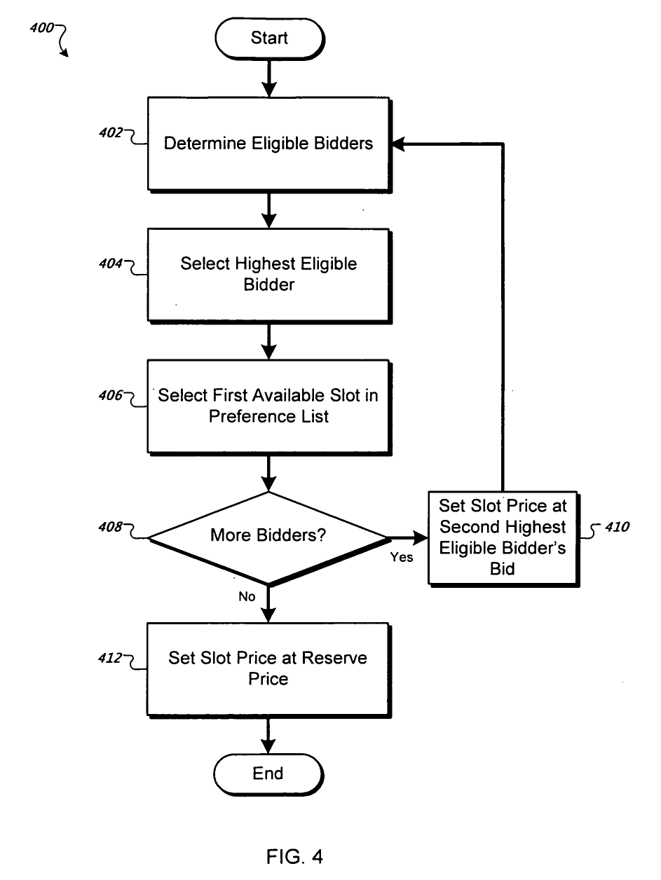

Optionally, process 300 charges (312) the bidder a fee for the advertisement placement. For example, the ad positioner 116 may calculate pricing fees based on the number of impressions of the ads 206a-b in the slots 202a-b. Pricing processes will be described in detail with respect to FIGS. 4-7 below.

FIG. 4 is a flow chart of a first example process 400 for pricing auctioned advertisement slots. In this example, each bidder's slot price is based on the bid of the next highest ranked bidder. Process 400 begins with determining (402) eligible bidders. For example, the highest eligible bidder may be a bidder that has not already been assigned a slot price and has a bid that is at least as high as a reserve bid. Process 400 selects (404) a highest eligible bidder. For example, the highest eligible bidder may have the highest bid from the remaining bidders that have not been previously selected by process 400 and have no assigned slot price. Process 400 selects (406) a first available slot in the selected bidder's preference list.

If the are more bidders (408) that have not yet been selected by process 400, then process 400 assigns a second highest bid as the slot price for the selected slot and bidder. If there are no remaining bidders, then process 400 assigns the reserve price to the last bidder.

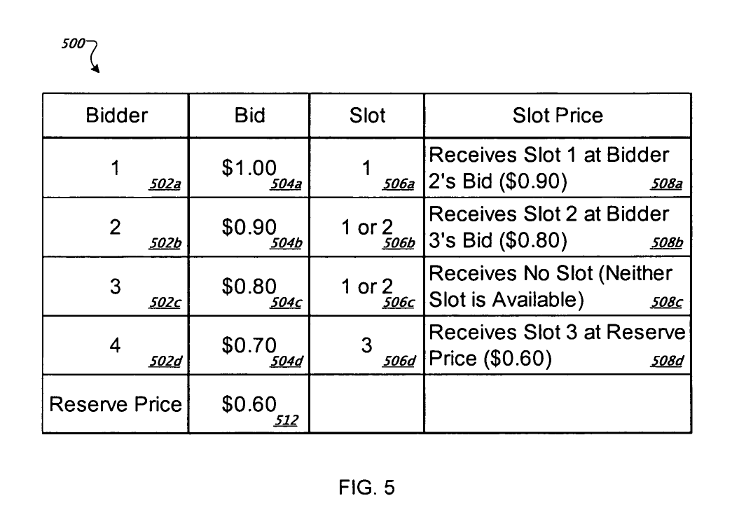

FIG. 5 is a table showing a first example of preference information 500 using process 400 of FIG. 4. The table 500 includes advertiser identifiers 502a-d, bids 504a-d submitted by the advertisers, slot preferences 506a-d for the ads, and slot prices 508a-d assigned by process 400. The table 500 also includes a reserve price 512 of $0.60, which sets a minimum cost for the ad placement.

In general for process 400, one bidder is assigned the reserve price, that being the last bidder 502d with the slot price 508d of $0.60. Each of the other bidders is assigned a slot price of the bidder ranked directly below each of them (e.g., the next highest bidder in the slot auction) if the bidder won a slot. The bidder 502a is assigned the slot price 508a of $0.90, which was submitted by the bidder 502b. The bidder 502a preferred slot 1 and was assigned this slot because it was the highest bidder.

The bidder 502b is assigned the slot price 508b of $0.80, which was submitted by the bidder 502c. The bidder 502b preferred slots 1 and 2. Slot 1 was already taken by the bidder 502a, so the bidder 502b received the slot 2. The bidder 502c is assigned no slot or slot price because both preferred slots 1 and 2 are already assigned.

The bidder 502d is assigned the slot price 508d, which is equal to the reserve price. The bidder 502d was assigned its preferred slot 3 because slot 3 was not previously assigned and was charged the reserve price because there were no more next highest bids to set the price.

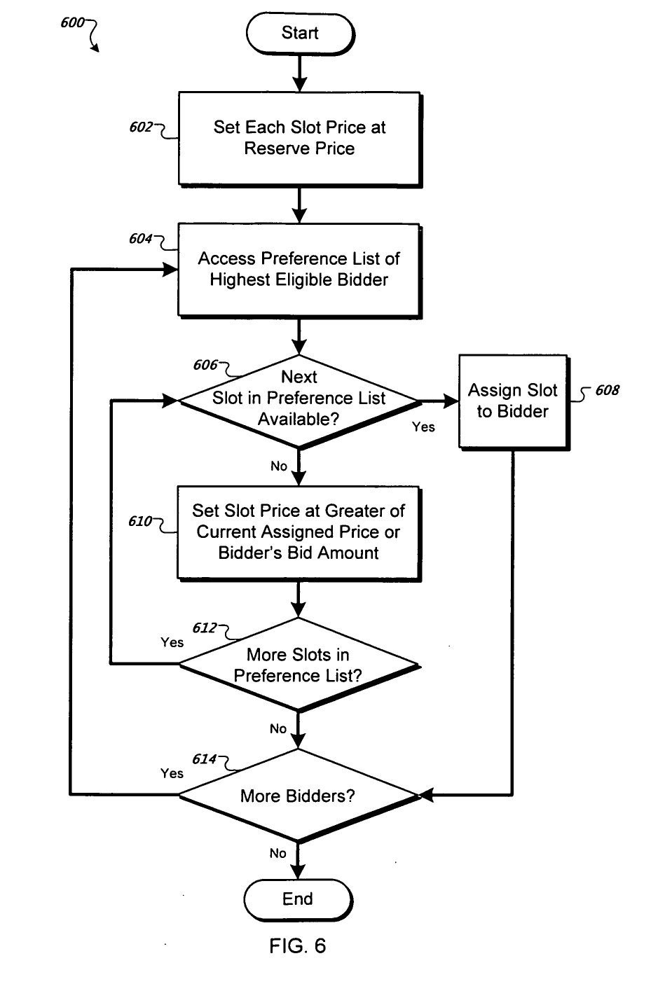

FIG. 6 is a flow chart of a second example process 600 for pricing auctioned advertisement slots. In this example, each bidder's slot price is based on the next highest bid for the slot assigned to the bidder. Process 600 begins with setting (602) each slot price at a reserve price. Process 600 accesses (604) a preference list of a highest eligible bidder. The highest eligible bidder may be, for example, a bidder that has not already been assigned a slot and has a bid that is at least as high as a reserve bid.

If a next slot in the preference list is available (606), then process 600 assigns (608) the slot to the selected bidder. Otherwise, if the slot is not available, then process 600 sets (610) the price of the slot, which has already been assigned to a previous highest bidder, at the bid of the current highest bidder if it is greater than the existing price of the slot.

If more slots exist in the preference list (612), then process 600 checks (606) the next slot in the preference list. Otherwise, if no more slots exist ,and more bidders exist (614), then process 600 accesses (604) the preference list of the next highest eligible bidder. Otherwise, if no more bidders exist, then process 600 ends. In general, if all bidders choose different slot preferences then all bidders may receive the reserve price.

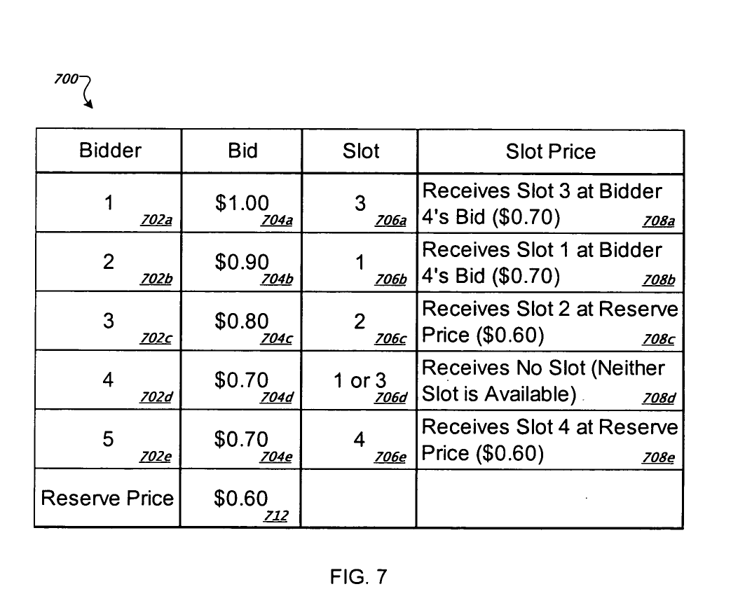

FIG. 7 is a table 700 showing a second example of an advertising slot auction using the process of FIG. 6. The table 700 includes advertiser identifiers 702a-e, bids 704a-e, slot preferences 706a-e, and assigned slot prices 708a-e. The table 700 also includes a reserve price 712 of $0.60.

Each of the bidders 702a-e is assigned a slot price of the bidder having the next highest bid for the same slot. The bidder 702a is assigned slot 3 with the slot price 708a of $0.70 from the bidder 702d who has the next highest bid for slot 3. The bidder 702b is assigned slot 1 with the slot price 708b of $0.70 from the bidder 702d who also has the next highest bid for slot 1. No other bidders bid on slot 2, so the bidder 702c receives slot 2 at the reserve price 712 of $0.60. Slots 1 and 3 are already taken by the bidders 702a-b, respectively, therefore the bidder 702d receives no slot and no slot price. No other bidders bid on slot 4, so the bidder 702e receives slot 4 at the reserve price 712 of $0.60.

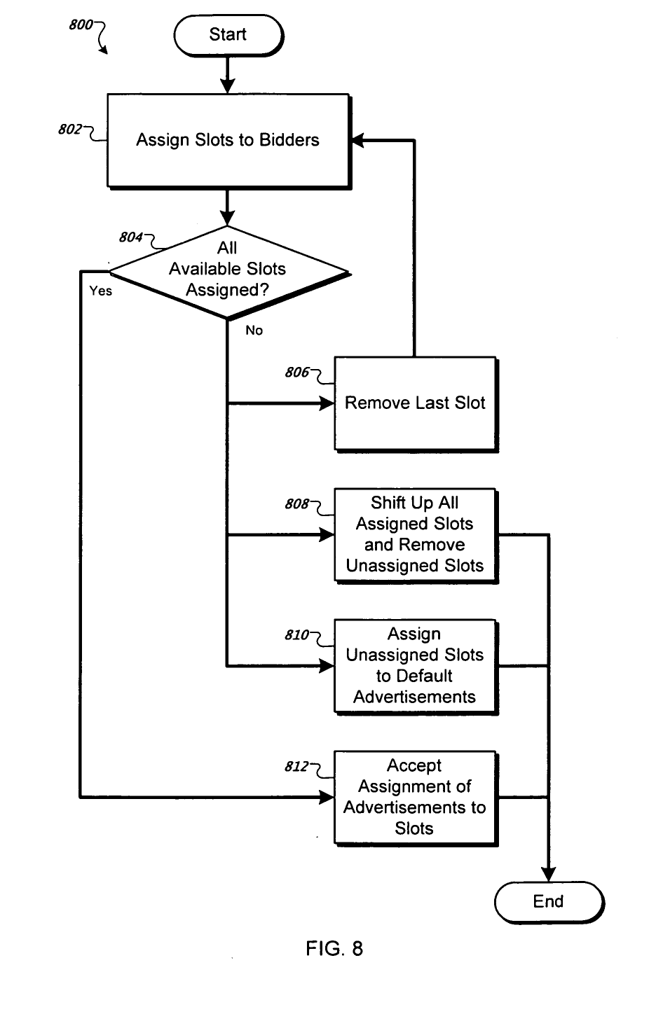

FIG. 8 is a flow chart showing an example process 800 for handling unassigned advertisement slots. Process 800 begins with assigning (802) slots to bidders. For example, process 300 may be use to assign slots to bidders.

If there exists an unassigned slot (804); then process 800 may remove (806) a slot and assign (802) the slots again, shift (808) all assigned slots up to fill in gaps left by unassigned slots and remove the unassigned slots, or assign (810) the unassigned slots to default advertisements. Otherwise, if no unassigned slots exist or the unassigned slots are filled up by shifting or by default advertisements, then process 800 terminates.

Removing a slot (806) may involve discarding a last advertisement slot and performing the slot assignment again. The omission of the last slot may result in one or more advertisers being assigned slots that previously went unassigned. Multiple removals may be performed. Default advertisements may include, for example, advertisements provided by the auction system 104 or public service announcements.

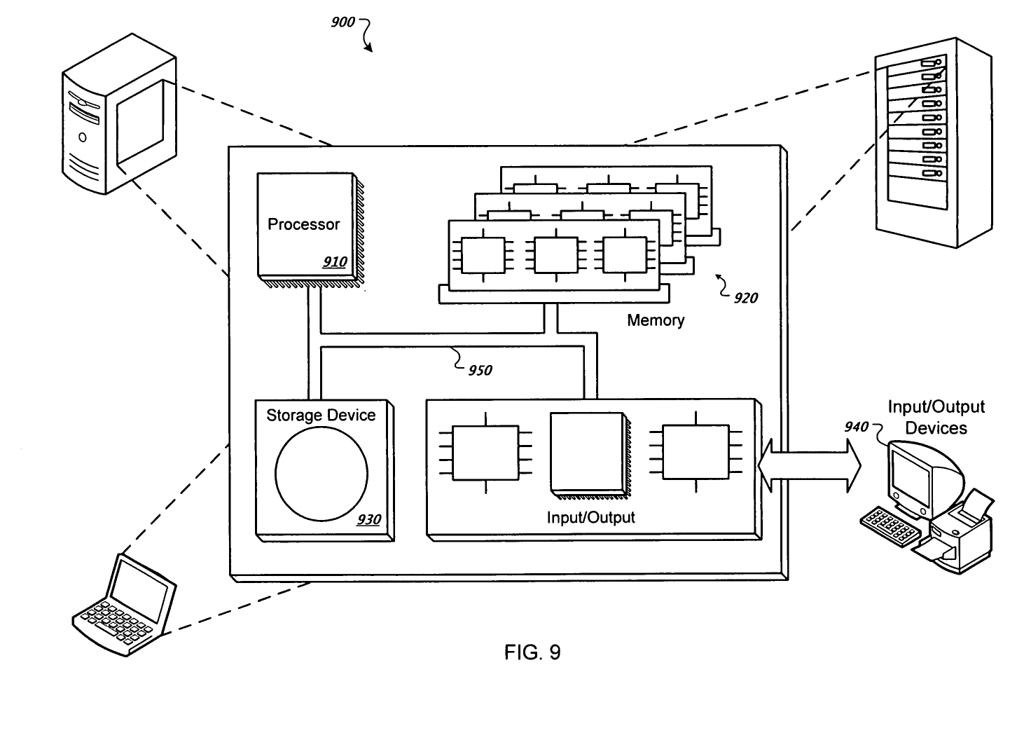

FIG. 9 is a schematic diagram of an example of a generic computer system 900. The system 900 can be used for the operations described in association with the methods 300, 400, 600, and 800 according to one implementation. For example, the system 900 may be included in either or all of the server 102, the advertisers 106a-c, the media 120a-d, and the web server 210.

The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for auctioning advertisement positions in a medium comprising:
receiving slot preference information comprising a first series of rankings at which an advertiser prefers to place a first advertisement relative to other advertisements on a medium, wherein two or more of the rankings in the first series are non-sequential;
receiving a single bid for placement of the first advertisement at any of the rankings in the first series; and
associating the first advertisement with a first ranking in the first series if the first ranking has not been previously associated with a different advertisement.

2. The method of claim 1, wherein the first series of rankings is formatted as a preference list ordered from a most preferred ranking for placement of the first advertisement to a least preferred ranking.

3. The method of claim 1, further comprising associating the first advertisement with a second ranking in the first series if the first ranking has been previously associated with the different advertisement and the second ranking is available for assignment.

4. The method of claim 1, further comprising receiving second slot preference information comprising a second series of rankings at which a second advertiser prefers to place a second advertisement and receiving a second single bid for placement of the second advertisement.

5. The method of claim 4, further comprising associating the second advertisement with a ranking in the second series before associating the first advertisement with a ranking in the first series if the second single bid is greater than the first single bid.

6. The method of claim 1, wherein the medium is selected from a group consisting of a web page, a printed page, a television time schedule, and a radio time schedule.

7. The method of claim 1, further comprising receiving from a second advertiser a second single bid for placement of a second advertisement, and assigning a default series of rankings for the second advertisement if slot preference information associated with the second single bid is not received.

8. The method of claim 7, wherein the default series of rankings orders the rankings sequentially.

9. The method of claim 1, further comprising receiving slot preference information and corresponding single bids from multiple advertisers, and processing the slot preference information from an advertiser submitting a higher bid before slot preference information from an advertiser submitting a lower bid.

10. The method of claim 1, wherein the single bid is a weighted bid comprising a click through rate for the first advertisement and a cost-per-impression bid.

11. The method of claim 1, wherein the first series of rankings is a subset of a greater set of available rankings permitted for the medium.

12. The method of claim 11, further comprising executing a default policy to eliminate or fill positions indicated by rankings if one or more of the available rankings are not associated with an advertisement.

13. The method of claim 12, wherein the default policy comprises voiding previous associations between rankings and advertisements, reducing the number of available rankings, receiving new slot preference information and a new associated single bid, and associating advertisements with rankings based on the new slot preference information and the new associated single bid.

14. The method of claim 12, wherein the default policy comprises associating default advertisements with rankings not associated with an advertisement.

15. The method of claim 12, wherein the default policy comprises incrementing the ranking of an advertisement that is ranked below a ranking that is not associated with an advertisement.

16. The method of claim 1, further comprising charging the advertiser a fee for associating the first advertisement with the first ranking, wherein the fee is substantially equal to a next highest single bid submitted by a second advertiser regardless of whether the second advertiser submitted slot preference information that included the first ranking.

17. The method of claim 1, further comprising charging the advertiser a fee for associating the first ranking with the first advertisement, wherein the fee is substantially equal to a single bid of another advertiser that prefers the first ranking and has the next highest bid.

18. The method of claim 1, wherein the slot preference information further comprises a preferred size, shape, or color of the advertisement.

19. A method for auctioning advertisement positions comprising:
receiving preference lists from advertising bidders, each list comprising a series of positions at which an advertising bidder prefers to place an advertisement on a medium;
receiving bids from the advertising bidders, each bid associated with a preference list;
determining that one or more of the advertising bidders are eligible if an advertisement of the one or more advertising bidders has not been previously assigned a position;
selecting a preference list of an eligible advertising bidder submitting a highest bid of the bids from the eligible one or more advertising bidders; and
assigning an advertisement of the eligible advertiser bidder with the highest bid to the first position listed in the selected preference list that has not been previously assigned to a different advertisement.

20. The method of claim 19, further comprising charging the eligible advertising bidder an amount substantially equal to a second highest bid of the eligible one or more advertising bidders.

21. The method of claim 19, further comprising receiving a reserve price for one or more of the positions.

22. The method of claim 21, further comprising determining an advertisement can not be assigned a position if a bid submitted by a bidder associated with the advertisement is not substantially equal to or greater than the associated reserve price.

23. A method for auctioning positions for advertisement placement comprising:
receiving preference lists and corresponding bids from advertising bidders, each list comprising positions at which an advertising bidder prefers to place an advertisement;
selecting an advertising bidder that has a highest bid among advertising bidders not previously selected; and
assigning a position price to each position in a preference list of the selected advertising bidder, wherein the position price of each of the positions is substantially equal to the greater of a highest position price assigned to the position in preference lists of unselected advertising bidders or the bid of the selected advertising bidder.

24. The method of claim 23, further comprising receiving a reserve price for one or more of the positions.

25. A system for determining placement of advertising comprising:
an interface to receive from an advertiser a single bid and an associated preference list that specifies positions the advertiser prefers to locate an advertisement on a medium, wherein the preference list comprises a listing of non-sequential rankings;
means for selecting the preference list using the single bid and assigning the advertisement to a ranking in the preference list that has not been previously assigned to another advertisement; and
an advertisement positioner that outputs a position for the advertisement based on the assigned ranking.
